(19) United States
(12) Patent Application Publication
(10) Pub. No.: US 2011/0117972 A1
(43) Pub. Date: May 19, 2011

(54) UNIVERSAL CASE FOR WIRELESS EARPIECE DEVICE

(76) Inventor: Derrick M. Smith, Clinton, MS (US)

(21) Appl. No.: 12/757,988

(22) Filed: Apr. 10, 2010

Related U.S. Application Data
(60) Provisional application No. 61/261,426, filed on Nov. 16, 2009.

(51) Int. Cl. H04M 1/00

(52) U.S. Cl. 455/569.1

(57) ABSTRACT

An apparatus for retaining wireless communication device(s) comprising: an outer enclosure, an upper portion, and a plurality of sidewalls therein defining at least one inner volume. The upper portion comprises a flexible securable lid which is fastenable to the front sidewall to form an outer enclosure. The device further comprises a cradle having a horseshoe-shaped indentation and guides which may be insertable and positionable onto both sides of the cradle and above the cradle. A clip is secured to an external back portion of the carrying case for attaching the carrying case to a belt or a bag. A kit and method of using the carrying case is also disclosed herein.

### CROSS-REFERENCE TO RELATED APPLICATION

The present application is related to and claims priority from prior provisional application Ser. No. 61/261,426, filed Nov. 16, 2009 which application is incorporated herein by reference.

### BACKGROUND OF THE INVENTION

1. Field of the Invention

The present invention relates generally to the field of storage cases and more specifically relates to storage cases for use with wireless communication devices.

2. Description of the Related Art

In the new age of wireless communication more and more individuals are using these devices to speak with business associates and loved ones in a variety of locations. State laws continue to crack down on the use of cellular phones while driving, and as a result drivers are turning to wireless communication devices as a hands free alternative. In spite of this increase in demand of wireless communication devices, there is a lack of adequate storage cases for containing these items in between uses. Users often resort to placing earpieces in their pocket, loose in their purse or in other make shift storage locations. Earpieces can be fragile items with delicate electronics that can easily be damaged or impaired by continuous improper storage.

Various attempts have been made to solve the above-mentioned problems such as those found in U.S. Pat. Nos. 6,370,401; 2001/0035242; 2005/0192045; and 2006/0121962. Although, these inventions have tried to solve the problem of creating a convenient and comfortable device storage for use with electronics they do not appear to provide a universal storage means for wireless communication devices that allows comfort and convenience as well as a safe place to store and carry such devices. This prior art is representative of storage cases. None of the above inventions and patents, taken either singly or in combination, is seen to describe the invention as claimed.

Ideally, a storage case should be comfortable to wear, convenient to use and be manufactured at a modest expense. Thus, a need exists for an efficient storage case for wireless communication devices to avoid the above-mentioned problems.

### BRIEF SUMMARY OF THE INVENTION

In view of the foregoing disadvantages inherent in the known storage case art, the present invention provides a novel storage case and system for wireless communication devices. The general purpose of the present invention, which will be described subsequently in greater detail is to provide comfortable, efficient storage and in-use protection for wireless communication devices.

A carrying case is disclosed herein for retaining at least one wireless communication device comprising: an outer enclosure having a bottom portion including an inclined angle, an upper portion, and a plurality of sidewalls defining at least one inner volume; wherein the sidewalls include a front sidewall opposite a rigid back sidewall, and two opposing side sidewalls; wherein the upper portion is a flexible securable lid which is fastenable to the front sidewall to form the outer enclosure of the carrying case for retaining at least one wireless communication device. The wireless communication device may comprise at least one right and/or left wireless cellular earpiece. The carrying case further comprises a cradle having a horseshoe-shaped indentation. The cradle is fastened to the back sidewall; and guides which are insertable and positionable onto both sides of the cradle and optionally above the cradle. The device may also comprise clip-fastening means secured to an external back portion of the carrying case for attaching the carrying case to a belt or a bag.

A kit is also described herein including at least one clip, a cradle, guide(s), a user instruction manual, and a wireless communication device.

Further, a method of using a carrying case is disclosed herein for retaining at least one wireless communication device comprising the steps of: removing at least one left or right earpiece of the wireless communication device from a user's ear; opening the lid of the carrying case; inserting a left or right earpiece of the wireless communication device into the carrying case forward end first; securing the left or right earpiece of the wireless communication device into the carrying case via the guide and cradle; and closing the lid to prevent the wireless communication device from excessive movement and damage. Optionally the carrying case may be strapped comfortably to a user's belt or to a bag. In this way the present invention provides a comfortable, safe and efficient storage means for electronic devices.

The present invention holds significant improvements and serves as a storage case and system for wireless communication devices. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, “universal case for wireless earpiece” device, constructed and operative according to the teachings of the present invention.

FIG. 1 shows a perspective view illustrating a carrying case in use according to an embodiment of the present invention.

FIG. 2 is a perspective view illustrating the carrying case holding a wireless communication device in an upright position according to an embodiment of the present invention of FIG. 1.

FIG. 3 is a rear perspective view illustrating a front portion of the case according to an embodiment of the present invention of FIG. 1.

FIG. 4A is a front perspective view illustrating the inner components of the carrying case according to an embodiment of the present invention of FIG. 1.

FIG. 4B is a rear perspective view illustrating the back portion of the carrying case with an attachment clip according to an embodiment of the present invention of FIG. 1.

FIG. 5 is a front perspective view illustrating the front of the present invention with a lid for securement according to an embodiment of the present invention of FIG. 1.

FIG. 6 is a flowchart illustrating a method of use according to an embodiment of the present invention of FIGS. 1-5.

The various embodiments of the present invention will hereinafter be described in conjunction with the appended drawings, wherein like designations denote like elements.

### DETAILED DESCRIPTION

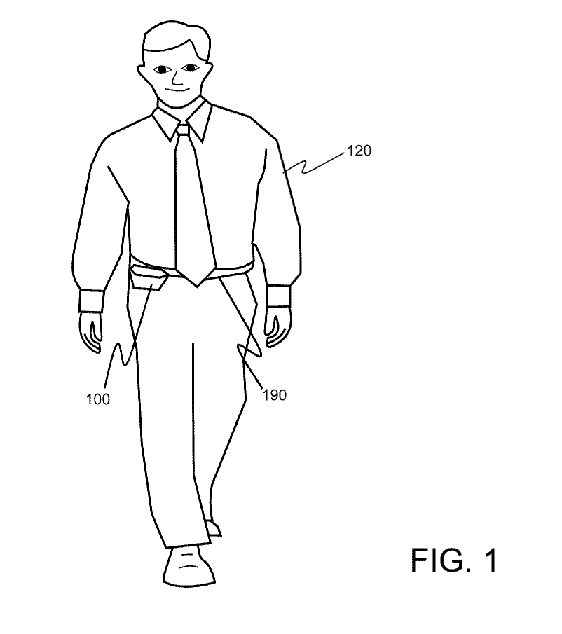

As discussed above, embodiments of the present invention relate to a storage case device and more particularly to a storage case as used to improve the comfort and convenience for storing wireless communication devices. Referring to the drawings by numerals of reference there is shown in FIG. 1, carrying case 100 in use according to an embodiment of the present invention.

Universal Case for Wireless Earpiece(s), of the present invention comprises at least one carrying case 100 device designed specifically to accommodate a plurality of wireless communication devices 110 of various sizes, shapes and configurations. At least one user 120 may store and/or carry their wireless earpiece 130 in a hard-shelled version of carrying case 100 wherein it will remain substantially protected from dirt and damage. Carrying case 100 can be clipped to a belt, bag or car sun visor substantially thereby substantially ensuring the protected wireless communication device 110 is in a convenient location.

The present invention in the embodiment shown preferably comprises a secure storage device for wireless cellular earpieces 130. Carrying case 100 may be a generally triangle-shape-bottomed hard-backed enclosure comprised of leather, faux leather, plastic or other suitable materials. The design may include a bottom tip that points downwardly and flat upper portion 104 that contains a flap of material that folds down and secures to main body 106 of the device forming lid 140. Lid 140 may be secured via Velcro®, clips, clasps or other such suitable attaching means. Upon reading this specification, it should be appreciated that, under appropriate circumstances, considering such issues as user preferences, design preference, structural requirements, marketing preferences, cost, available materials, technological advances, etc., other securing arrangements such as, for example, pins, snaps, and hooks, etc., may also be sufficient.

Interior compartment 150 (inner volume 170 herein embodied) of carrying case 100 preferably comprises two key components: cradle 154 and guides 158. Cradle 154 may be attached to the interior center and rear of carrying case 100 and look similar to a small box with a horseshoe-shaped indentation 160 preferably toward the front. Guides 158 may be inserted and positioned onto both sides of cradle 154. The forward portion of guides 158 may be attached above cradle 154 and extend internally to the rear where they may attach below cradle 154. In a preferred embodiment at least one clip 180 is substantially secured to the external back portion of carrying case 100 which allows for attaching the device to a belt, as shown or a bag. Carrying case 100 may be designed to fit a variety of wireless communication devices 110, including both left earpiece 112 and right earpiece 114.

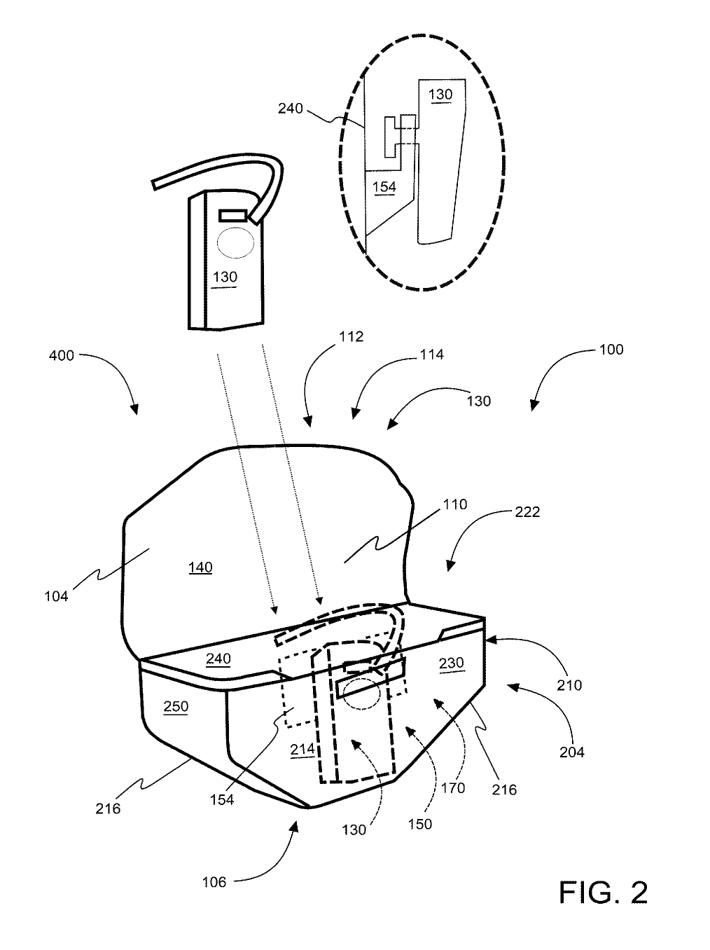

Referring now to FIG. 2, illustrating carrying case 100 holding wireless communication device 110 in an upright position according to an embodiment of the present invention of FIG. 1.

Carrying case 100 of the present invention is designed for retaining at least one wireless communication device 110 and preferably comprises: an outer enclosure 210 having a bottom portion 214, an upper portion 222, and a plurality of sidewalls defining at least one inner volume 170; wherein the sidewalls preferably include front sidewall 230 opposite back sidewall 240, and two opposing side sidewalls 250. Upper portion 222 may be a flexible securable lid 140 which is fastenable to front sidewall 230 to form outer enclosure 210 of carrying case 100 for retaining at least one wireless communication device 110. Wireless communication device 110 may comprise at least one wireless cellular earpiece 130. Bottom portion 214 may comprise at least one inclined angle 216, as shown. Inclined angles 216 are designed into the present invention to provide a comfortable fit for user 120 when in a sitting position or standing position (as shown in FIG. 1). In other embodiments bottom portion 214 may comprise a flat-bottom profile. Enclosure 204 of the present invention may comprise sidewalls that are manufactured from a one-piece or multi-piece construction and may be sewed, attached via adhesives or other means to form the desired shape of enclosure 204. Wireless communication device 110 may be inserted as shown via arrows and is preferably held as shown in magnified view in cradle 154.

Carrying case 100 further comprises at least one cradle 154. Cradle 154 comprises horseshoe-shaped indentation 160 which is preferably fastened to back sidewall 240. Cradle 154 serves to ‘cradle’ wireless communication device 110. Carrying case 100 may further comprise at least one guide 158 which is/are preferably insertable and positionable onto both sides of cradle 154. In certain embodiments guides 158 are attachable above cradle 154. Guides 158 may also be attachable above cradle 154 and extend internally to the rear where they attach below cradle 154.

Carrying case 100 is preferably designed to fit at least one right earpiece 114 or left earpiece 112 from wireless communication device(s) 110. In yet another embodiment carrying case 100 of the present invention may fit left and/or right earpiece, 112 and 114, respectively from wireless communication device(s) 110.

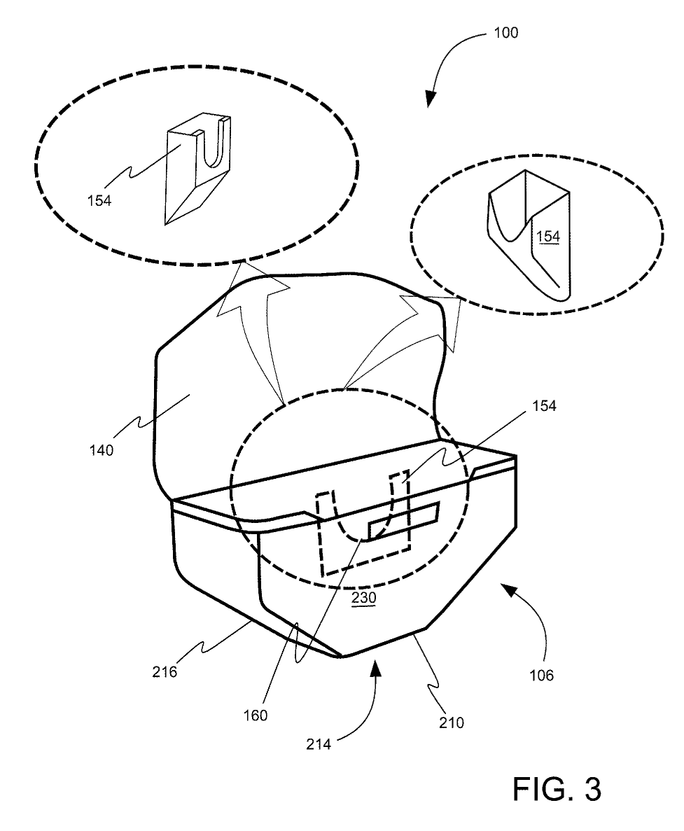

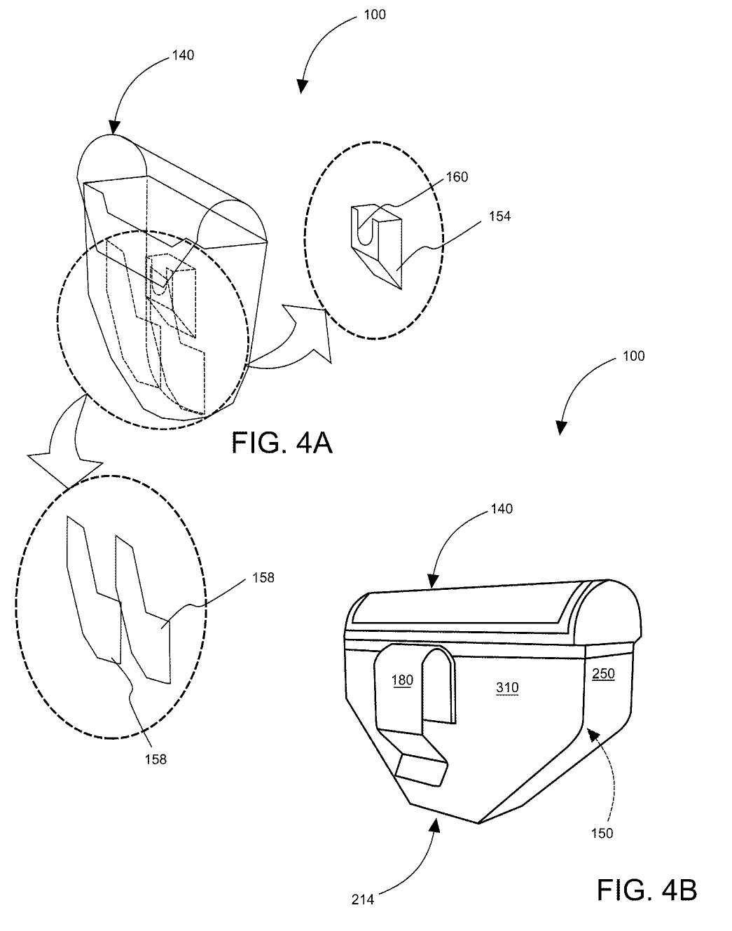

Referring now to FIGS. 3 and 4A, both showing a front perspective view illustrating inner components of carrying case 100 according to an embodiment of the present invention of FIG. 1. FIG. 4B is a rear perspective view illustrating back portion of the carrying case 100 with attachment clip 180. Cradle 154 is shown in a magnified view, in two different embodiments, the right a curved ergonomic version, the left an alternate embodiment. In certain embodiments the edges on cradle 154 may be rounded thereby opening up horseshoe-shaped indentation 160 insert for wireless earpiece 130.

In FIG. 4A cradle 154 is again illustrated, in this instance to guides 158. Guides 158 as mentioned hold wireless earpiece 130 in a vertically-held position, thereby effectively protecting it for damage and for ease of storing/removing. Cradle 154 and guides 158 are enclosed within interior compartment 150 when lid 140 is shut, as shown. Guides 158 provide a supporting and stabilizing means as wireless communication device 110 and/or wireless earpiece 130 is held therebetween.

Referring now again to FIG. 4B, back sidewall 310 of carrying case 100 preferably comprises clip 180, as shown. Clip 180 preferably functions as a clamping mechanism/means for the temporary attachment of carrying case 100 to belt 190 of user 120 as shown in FIG. 1. Clip-fastening means (herein embodying clip 180) such as the biasing version shown in the present figure is substantially secured to an external back portion of carrying case 100 that is appropriate for attaching the present invention to a belt, as shown in FIG. 1 or a bag (not shown). Clip 180 is preferably spring-loaded and may comprise two biasing prongs. By using a biasing action, the two prongs may be pinched at the top of clip 180. When the prongs are biased apart they open, and when released, the spring-action preferably draws the two prongs shut, thereby securing carrying case 100 onto belt 190 of user 120. Further in a like action, clip 180 may attach to a sun visor in a vehicle or couple to a strap on a purse or bag. In this way the present invention may be conveniently located for quick and efficient access.

Additionally, it should be noted that the use of clip 180 is optional. User 120 may choose to transport wireless communication device 110 in carrying case 100 without the use of clip 180. For example, user 120 may decide to place carrying case 100 inside a glove box, a personal bag such as but not limited to a purse, gym, duffel, briefcase, or piece of luggage.

Kit 400 of the present invention may include at least one clip 180, at least one cradle 154, at least one guide 158, a user instruction manual, and at least one wireless communication device 110. Carrying case 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit 400 contents or arrangements such as, for example, including more or less components, customized parts, different color combinations, parts may be sold separately, etc., may be sufficient. Further, it should be appreciated that carrying case 100 may also carry/store other items and/or devices including other communication devices and related items.

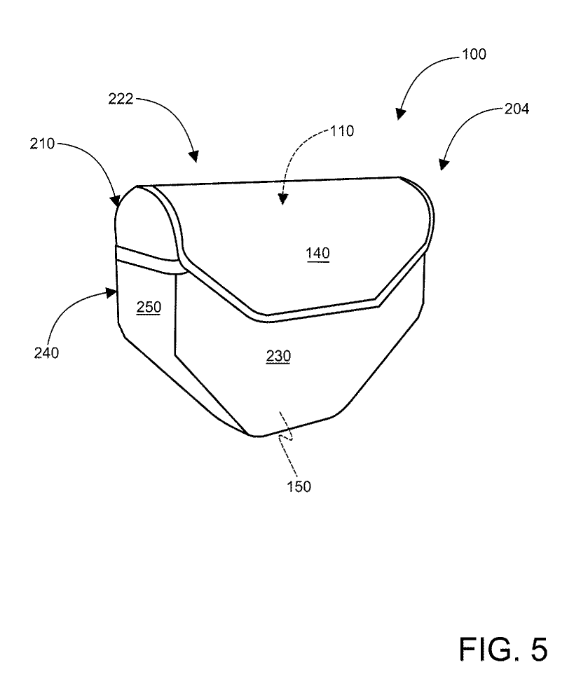

Referring now to FIG. 5, a front perspective view illustrating the front of the present invention, carrying case 100 comprising a securable lid 140 according to an embodiment of the present invention of FIG. 1.

Lid 140 is preferably flexible and securable and as mentioned previously fastenable to front sidewall 230 to form outer enclosure 210 of carrying case 100 for retaining at least one wireless communication device 110. Carrying case 100 may comprise semi-rigid material or in other embodiments may comprise leather, faux leather, plastic or other suitable materials, as previously mentioned. Upon reading this specification, it should be appreciated that, under appropriate circumstances, considering such issues as user preferences, design preference, structural requirements, marketing preferences, cost, available materials, technological advances, etc., other materials such as, for example, plastics of various types, composite(s), rubber, cloth, etc., may be sufficient. Consumer(s) who use and wish to protect wireless communication devices 110 will appreciate the versatility and convenience of carrying case 100.

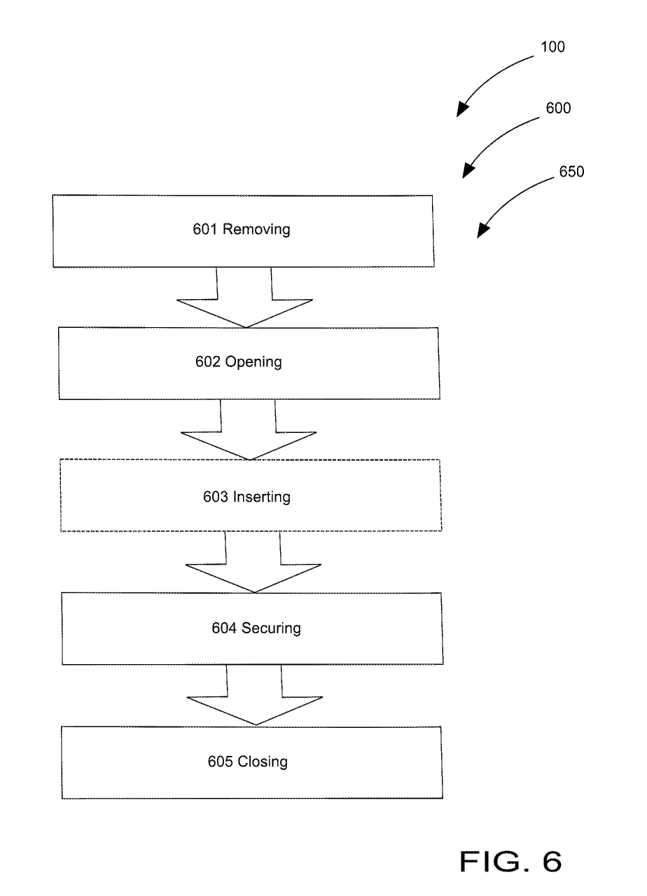

Referring now to FIG. 6, showing a flowchart 650 illustrating a method of use 600 according to an embodiment of the present invention of FIGS. 1-5.

A method of use 600 is illustrated in flowchart 650 for retaining at least one wireless communication device 110 within carrying case 100 comprising the steps of: step one 601 removing at least one left or right earpiece of wireless communication device 110 from a user's ear; step two 602 opening lid 140 of carrying case 100; step three 603 inserting left or right earpiece (112 and 114, respectively) of wireless communication device 110 into carrying case 100 forward end first; step four 604 securing said at least one left or right earpiece (112 and 114, respectively) of wireless communication device 110 into carrying case 100 via at least one guide 158 and a cradle 154; and step five 605 closing lid 140 to prevent wireless communication device 110 from excessive movement and resulting damage.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A carrying case for retaining at least one wireless communication device comprising:
an outer enclosure having a bottom portion, an upper portion, and a plurality of sidewalls defining at least one inner volume;
wherein said sidewalls include a front sidewall opposite a back sidewall, and two opposing side sidewalls;
wherein said upper portion is a flexible securable lid which is fastenable to said front sidewall to form said outer enclosure of said carrying case for retaining at least one wireless communication device; and
wherein said wireless communication device comprises at least one wireless cellular earpiece.

2. The carrying case of claim 1 further comprising at least one cradle.

3. The carrying case of claim 2 wherein said cradle comprises a horseshoe-shaped indentation.

4. The carrying case of claim 3 wherein said cradle is fastened to said back sidewall.

5. The carrying case of claim 1 further comprising at least one guide.

6. The carrying case of claim 1 further comprising at least one clip-fastening means.

7. The carrying case of claim 1 wherein said bottom portion comprises at least one inclined angle.

8. The carrying case of claim 1 wherein said back sidewall comprises a rigid back.

9. The carrying case of claim 5 wherein said guides are insertable and positionable onto both sides of the cradle.

10. The carrying case of claim 5 wherein said guides are attachable above said cradle.

11. The carrying case of claim 10 wherein said guides are attachable above said cradle and extend internally to the rear where they attach below said cradle.

12. The carrying case of claim 6 wherein said clip-fastening means is secured to an external back portion of said carrying case that is appropriate for attaching the item to a belt.

13. The carrying case of claim 6 wherein said clip-fastening means is secured to an external back portion of said carrying case that is appropriate for attaching the item to a bag.

14. The carrying case of claim 1 wherein said carrying case fits at least one right earpiece from said wireless communication device.

15. The carrying case of claim 1 wherein said carrying case fits at least one left earpiece from said wireless communication device.

16. The carrying case of claim 1 wherein said carrying case fits at least one left and/or right earpiece from said wireless communication device(s).

17. A carrying case for retaining at least one wireless communication device comprising:
an outer enclosure having a bottom portion including an inclined angle, an upper portion, and a plurality of sidewalls defining an inner volume;
wherein said sidewalls include a front sidewall opposite a rigid back sidewall, and two opposing side sidewalls;
wherein said upper portion is a flexible securable lid which is fastenable to said front sidewall to form said outer enclosure of said carrying case for retaining at least one said wireless communication device;
wherein said wireless communication device comprises at least one right and/or left wireless cellular earpiece;
a cradle having a horseshoe-shaped indentation wherein said cradle is fastened to said back sidewall;
guides which are insertable and positionable onto both sides of said cradle and/or above said cradle; and
clip-fastening means secured to an external back portion of said carrying case for attaching said carrying case to a belt or a bag.

18. The carrying case of claim 17 wherein said carrying case further comprises a kit including said at least one clip, said cradle, said guide(s), a user instruction manual, and said wireless communication device.

19. The carrying case of claim 17 wherein said carrying case comprises semi-rigid material.

20. A method of using a carrying case for retaining at least one wireless communication device comprising the steps of:
removing at least one left or right earpiece of said wireless communication device from ear;
opening a lid of said carrying case;
inserting left or right earpiece of said wireless communication device into said carrying case forward end first;
securing said at least one left or right earpiece of said wireless communication device into said carrying case via at least one guide and a cradle; and
closing said lid to prevent said wireless communication device from excessive movement and damage.
